(19) United States
(12) Patent Application Publication
(10) Pub. No.: US 2009/0077999 A1
(43) Pub. Date: Mar. 26, 2009

(54) System And Method For Dispensing A Cooled Beverage

(76) Inventors: Andrew Chapman, Peterborough (GB); Andrew Hillis, London (GB); Howard Biddle, Cambridge (GB); Jeremy Carey, Huntington (GB)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/224,996

(22) PCT Filed: Mar. 5, 2007
(86) PCT No.: PCT/GB2007/000770

§ 371 Date: Sep. 11, 2008

(30) Foreign Application Priority Data
Mar. 20, 2006 (GB) 0605608.9

(51) Int. Cl. B01D 9/04; F25D 17/02

(52) U.S. Cl. 62/544; 62/434

(57) ABSTRACT

The present invention relates to a system for cooling a beverage, the system comprising: a beverage line (5) connectable to a beverage supply for transporting beverage from the beverage supply through an insulated carrier to a dispensation site (1), a cooling medium generator (2) for generating a cooling medium; a cooling line (6) for transporting the cooling medium from the cooling medium generator through the insulated carrier so as to allow heat exchange between the cooling medium in the cooling line and the beverage in the beverage line; and a pump (3) for pumping the cooling medium through the cooling line. The cooling medium generator (2) is an ice slush generator. The present invention also relates to a method of cooling a beverage flowing through a beverage line using ice slush as a cooling medium.

The present invention relates to systems and a method for dispensing a beverage. In particular, the present invention relates to systems and a method for dispensing a beverage at a low temperature.

Many beverages including beers, lagers, soft drinks, milk shakes, wines and spirits are beneficially served at low temperatures. If the temperature of the beverage is too high, the quality and the taste of the beverage may be impaired. In addition, recent consumer trends have increased the demand for beverages to be served at a lower temperature, for example, below 3° C. In order to meet consumer expectations, it is desirable to dispense beverages at a consistent low temperature.

A particular problem has been found in dispensing draft beverages at low and consistent temperatures. By “draft beverages” is meant beverages which are stored at a point remote from the point of dispensation and transferred on demand to the point of dispensation through a beverage line. Typically the transfer is achieved using a pumping mechanism. For instance, it is common in public houses and bars for beverages to be stored in a cellar or a storage room and transferred to the bar area where dispensation occurs at a font using a mechanical pump or a gas pressurised system.

One problem that arises when dispensing draft beverages is that the length of the beverage line between the cellar/storage room and the dispensation site may be many metres and there is a tendency for beverage in the beverage lines to increase in temperature during transit. In an attempt to address this problem, it is known to provide a cooler in or near the cellar/storage room to cool the beverage and then to transport the beverage to the dispensation site inside an insulated and cooled conduit known as a “python”. The cooler typically comprises an ice bank and a water bath, the water in the water bath being cooled by the ice bank. The beverage line passes from the cellar/storage room through the water bath and beverage contained in the beverage line is thus cooled. The cooled beverage then flows through the python to the dispensation site, the python also carrying a cooling circuit through which cold water from the water bath is circulated. This solution is not ideal. The cold water circulating through the cooling circuit will typically rise about 1° C. in temperature during circulation and this warmer water is typically returned to the water bath which may result in melting of the ice bank.

It is also known to provide a flash cooler or a passive heat exchanger at or near the dispensation site e.g. under the bar. This may be provided in addition to the primary cooler in or near the cellar/storage room. With such an arrangement, it is possible to cool beverages to around 3° C. However, flash coolers are undesirable because they take up a considerable amount of space under the bar, space which could be used to store, for example, glassware or bottled beverages. Furthermore, flash coolers generate a significant amount of heat thus creating an unpleasant working environment for bar staff or leading to increased air conditioning requirements. Passive heat exchangers are generally smaller and do not generate heat but they are not capable of sustained dispense of the beverage at temperatures lower than around 3° C. under conventional operating conditions.

Three stage cooling systems are known in which cooling is first achieved using a water bath/ice bank cooler in or near the cellar/storage room. Further cooling is obtained using a flash cooler or a passive heat exchanger located under the bar and then a cooling loop in the cooling circuit at the dispense font prevents temperature rise between the flash cooler/passive heat exchanger prior to dispensation. Such systems generally dispense beverages from a dispense tap at around 3° C. As mentioned above, consumers now desire even colder beverages and this cannot be achieved with these known three-stage cooling systems.

In an attempt to reduce the temperature of beverages even further and also to form ice/frost effects on the exterior of the font for aesthetic reasons, the use of a cooling medium such as a 30% glycol solution has been proposed. However, the high amount of glycol leads to a cooling medium which can have a temperature as low as −30° C. (although typically a glycol cooling medium will be used at a temperature of around −6° C.). Such a low temperature cooling medium can result in cooling of the beverage to below the filtration temperature leading to an irreversible formation of precipitates which cloud the beverage. In extreme cases, the low temperature can lead to freezing of the beverage. Water used for cleaning the beverage lines is even more prone to freezing (as it has a higher freezing point than that of an alcoholic or sugar-containing beverage). As a result, it is necessary to switch off circulation of the glycol solution cooling medium when the line is to be cleaned. This results in additional time and effort and a loss of visual appeal of the font during cleaning since the ice or frost effect cannot be maintained until circulation of the cooling medium restarts.

It is a preferred aim of the present invention to provide systems and method for cooling a beverage wherein the beverage can be cooled to a temperature below 3° C. but wherein the risk of freezing of the beverage or forming precipitates is ameliorated.

The present invention is based on the finding that ice slush can be used as a cooling medium for cooling a beverage. Ice slush (also known as binary ice) is a two-phase mixture (slurry) of ice particles suspended in a liquid phase consisting predominantly of water.

Accordingly, in a first aspect, the present invention provides a system for cooling a beverage comprising:

a beverage line connectable to a beverage supply for transporting beverage from the beverage supply through an insulated carrier to a dispensation site;

a cooling medium generator for generating a cooling medium;

a cooling line for transporting the cooling medium from the cooling medium generator through the insulated carrier so as to allow heat exchange between the cooling medium in the cooling line and the beverage in the beverage line; and

a pump for pumping the cooling medium through the cooling line,
wherein the cooling medium generator is an ice slush generator.

By providing an ice slush generator, ice slush can be used as a cooling medium to reduce the temperature of the beverage to below 3° C., for example below 0° C., but with a reduced risk of the beverage freezing or forming precipitates. The temperature of ice slush is typically around −3° C. and will remain approximately isothermal throughout the system. At such a temperature, the risk of the beverage freezing or clouding is minimal.

Preferably, the cooling medium generator is one which can generate a mixture of up to 40% ice particles in (predominantly) water. Such a mixture is easily pumpable through the cooling line by the pump. Preferably the cooling medium generator is one which can generate a mixture of 15-40% ice particles in the liquid phase, and more preferably 30-40% ice particles in the liquid phase.

The cooling medium generator may be a scraped wall slush generator. Such a generator includes a refrigeration unit which cools a wetted surface which is continuously scraped to form a two phase mixture of small ice crystals suspended in a liquid phase (predominantly water).

The system preferably further comprises a cooling medium reservoir in which ice slush generated by the cooling medium generator can be stored. The reservoir is preferably insulated and may be remote from the cooling medium generator. It may contain an agitator. The reservoir allows the system to damp out demand fluctuations and thus enables the generator to be sized for the mean rather than the peak load.

The beverage line is connectable to a beverage supply, e.g. a beverage storage vessel such as keg or barrel. The beverage line may be formed predominantly of standard piping e.g. 9.5 mm (⅜″) piping. There may be more than one beverage line, each line being connectable to its respective beverage supply and extending through the insulated carrier to the dispensation site.

The beverage line preferably includes a beverage line portion which passes through the cooling medium reservoir prior to the beverage line passing through the insulated carrier. Preferably, the beverage line portion is a coiled portion which can be immersed in the ice slush in the reservoir. The amount of coil immersed can be varied to determine the extent of heat exchange and hence the extent of cooling of the beverage.

In preferred embodiments, the beverage line portion in the reservoir is adapted so that the temperature of the beverage may be reduced to below 3° C. as it passes through the reservoir. More preferably, the beverage line portion is adapted so that the temperature of the beverage may be reduced to below 2° C., and most preferably to below 0° C., as it passes through the reservoir. A temperature of below 0° C. may be achieved by using a coiled beverage line portion having a diameter of 7.9 mm ( 5/16″) and an immersed length of around 8.5 metres.

Preferably, it is possible to vary the length of the beverage line portion passing through the cooling medium reservoir so that a user can vary the dispense temperature of a beverage. For example, the user may wish to dispense a certain beverage at a higher (more conventional) temperature, e.g. around 7° C. In this case, the length of the beverage line portion passing through the cooling medium reservoir can be reduced (from that used to obtain the lower temperatures e.g. 3-0° C.).

After passing through the reservoir, the beverage line passes through the insulated carrier to the dispensation site.

Preferably, the cooling line extends from the cooling medium generator (rather than from the reservoir) through the insulated carrier to the dispensation site. The cooling line preferably forms part of a circuit, the circuit including the cooling line extending from the cooling medium generator through the insulated carrier to the dispensation site and a return line extending from the dispensation site through the insulated carrier to the cooling medium reservoir or generator, but most preferably to the reservoir. The cooling line and return line typically have a diameter of 15 mm.

The system preferably includes an insulated carrier of the type known as a “python” which comprises a tubular sleeve formed of insulating plastics material. The length of python is unlimited but, typically, will be between 3 and 300 metres. A length of around 30 metres is most typical. The cooling line and the return line preferably pass through the python close to its axial centre with one or more beverage lines running co-axially with the cooling/return lines.

There could be at least one further insulated carrier, each further insulated carrier carrying a further cooling line and return line through which ice slush is pumpable with at least one further beverage line running coaxially with the further cooling/return lines.

The system may include a secondary cooler at or near the dispensation site (although it may be provided at any point between the point of connection of the beverage line to the beverage supply and the dispensation site). The secondary cooler may be a passive heat exchanger which, preferably, can be flooded with ice slush from the cooling line. The passive heat exchanger preferably includes a cooling coil through which the beverage from the beverage line can flow to allow heat exchange between the beverage in the cooling coil and the ice slush. Most preferably, the passive heat exchanger is as described in published application GB2417064.

In preferred embodiments, the system further comprises, at the dispensation site, a font having at least one dispense tap. The font preferably houses a cooling loop which is in thermal contact with the beverage line within the font thus allowing cooling of the beverage to reduce its temperature further or to maintain the temperature of the beverage. The system may be adapted so that the entire flow of the cooling medium may flow through the cooling loop or the cooling loop may be branched off from the cooling line so that at least a portion, but not necessarily all, of the cooling medium flow may pass through the cooling loop.

The font preferably includes a condensation mechanism comprising a condensation plate and a condensation line. The condensation line is in thermal contact with the condensation plate and may be formed of or may branch off from the cooling loop or cooling line so that ice slush can flow through the condensation line. This allows cooling of the condensation plate to such an extent that condensation can form and then freeze on the condensation plate thus providing an “iced” or “frosted” font which has aesthetic appeal.

In embodiments with more than one beverage line, there may be more than one dispense font at the dispensation site or there may be at least one dispense font with multiple dispense taps. Where there is more than one dispense font, it may not be necessary to provide every dispense font with a cooling loop and/or a condensation mechanism.

In a second aspect, the present invention provides a method of cooling a beverage flowing through a beverage line from a beverage supply to a dispensation site, the beverage line passing through an insulated carrier, the method comprising:

pumping a cooling medium through a cooling line inside the insulated carrier thereby allowing heat exchange between the cooling medium in the cooling line and the beverage in the beverage line,

wherein the cooling medium is an ice slush.

By pumping an ice slush cooling medium through the cooling line, it is possible to reduce the temperature of the beverage to below 3° C., for example below 0° C., but with a reduced risk of the beverage freezing or forming precipitates.

Preferably, the method further comprises generating an ice slush cooling medium, for example using an ice slush generator as described above in relation to the first aspect.

The method may include generating the ice slush from water which may contain small amounts, for example, up to 10%, of a freezing point suppressant such as glycol.

In preferred embodiments, the method further comprises storing ice slush in a cooling medium reservoir.

The method preferably comprises flowing the beverage through a beverage line portion (optionally coiled) immersed in ice slush in the cooling medium reservoir prior to flowing through the beverage through the insulated carrier. As a result of this step, the beverage is cooled to below 3° C., more preferably to below 2° C., and most preferably to below 0° C., as it passes through the beverage line portion within the cooling medium reservoir.

After flowing the beverage through the beverage line portion immersed in the ice slush in the reservoir, the beverage flows through the beverage line within the insulated carrier to the dispensation site.

The method preferably comprises pumping the ice slush from the ice slush generator (rather than from the reservoir) through the cooling line through the insulated carrier to the dispensation site. The ice slush obtained directly from the generator will have a higher ice fraction than ice slush from the reservoir (which will have undergone some heat exchange with the beverage in the immersed beverage line portion) and thus by pumping ice slush from the generator rather than from the reservoir, it is possible to maintain the lowest possible temperature of the beverage in the beverage line as it passes through the insulated carrier.

Preferably, the slush ice is pumped back to the generator or reservoir after flowing to the dispensation site through a return line extending from the dispensation site through the insulated carrier to the cooling medium reservoir/generator. Most preferably, it is pumped back to the reservoir.

In some embodiments, the method may include cooling the beverage at a secondary cooler. Preferably, the secondary cooler is as described above in relation to the first aspect.

The method may also include cooling the beverage at a cooling loop in a dispense font or maintaining the low temperature of the beverage using a cooling loop. Preferably, the cooling loop is as described above in relation to the first aspect.

In preferred embodiments, the method also comprises forming condensation on the font. The condensation which may become ice or frost is preferably formed using a condensation mechanism as described above in relation to the first aspect.

In a third aspect, the present invention provides a system for cooling a beverage comprising:

a beverage line connectable to a beverage supply for transporting beverage from the beverage supply through an insulated carrier to a dispensation site;

a cooling line containing a cooling medium, the cooling line being in thermal contact with the beverage line so as to allow heat exchange between the cooling medium in the cooling line and the beverage in the beverage line; and

a pump for pumping the cooling medium through the cooling line,

wherein the cooling medium is ice slush.

By providing a cooling line containing ice slush it is possible to reduce the temperature of the beverage to below 3° C., for example below 0° C., but with a reduced risk of the beverage freezing or forming precipitates.

Preferably, the ice slush is a mixture of up to 40% ice particles in (predominantly) water, more preferably a mixture of 15-40% ice particles in the liquid phase and most preferably a mixture of 30-40% ice particles in the liquid phase. Such a mixture is easily pumpable through the cooling line by the pump. The temperature of the ice slush is typically around −3° C. and will remain approximately isothermal throughout the system. This allows cooling of the beverage to the desired low temperature and maintenance of the low temperature through the entire system. When the ice slush is at a temperature around −3° C., there is minimal risk of the beverage freezing.

The ice slush preferably contains up to 10% glycol.

The system preferably further comprises a cooling medium generator and, optionally, a cooling medium reservoir, as described above in relation to the first aspect.

Preferably, the beverage line passes from the beverage supply, e.g. a vessel such as keg, and through the cooling medium reservoir prior to passing through the insulated carrier to allow a reduction in the temperature of the beverage to below 3° C., more preferably below 2° C. and most preferably below 0° C. as described above in relation to the first aspect.

After passing through the reservoir, the beverage line passes through the insulated carrier to the dispensation site.

Preferably, the cooling line extends from the cooling medium generator (rather than from the reservoir) through the insulated carrier to the dispensation site. The cooling line preferably forms part of a circuit, as described above in relation to the first aspect.

The system preferably includes an insulated carrier of the type known as a “python” as described above in relation to the first aspect.

The system may include a secondary cooler at or near the dispensation site (although it may be provided at any point between the connection of the beverage line to the beverage supply, e.g. a storage vessel such as a keg, and the dispensation site). The secondary cooler is preferably as described above in relation to the first aspect.

In preferred embodiments, the system further comprises, at the dispensation site, a font having at least one dispense tap. The font houses a cooling loop as described above in relation to the first aspect. The system may also include a condensation mechanism as described above in relation to the first aspect.

A preferred embodiment of the present invention will now be described, by way of example only, with reference to the accompanying drawings in which:

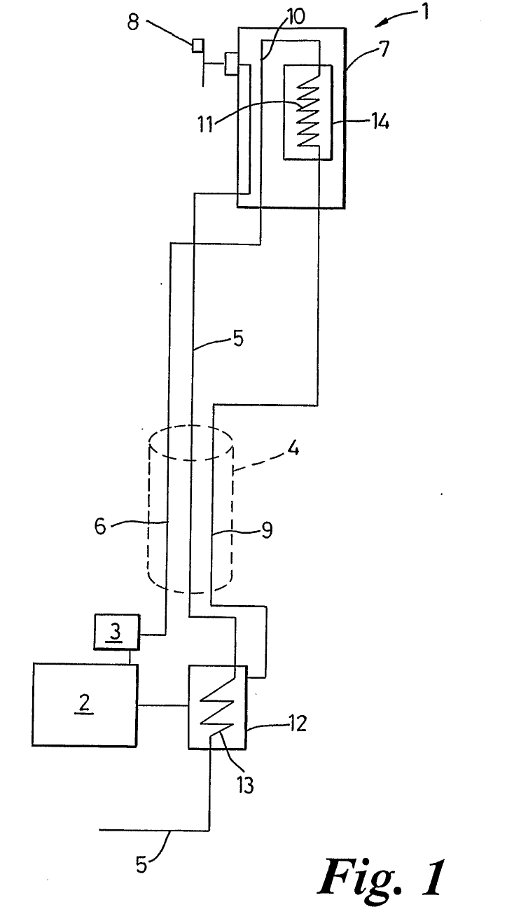

FIG. 1 shows a first preferred embodiment of the present invention;

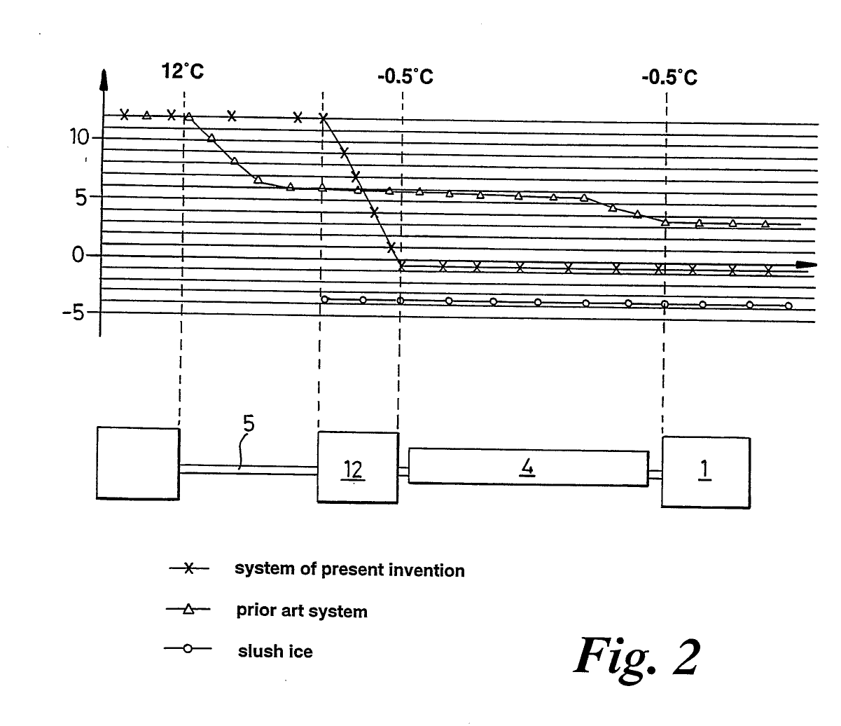

FIG. 2 shows the results obtained using the first preferred embodiment;

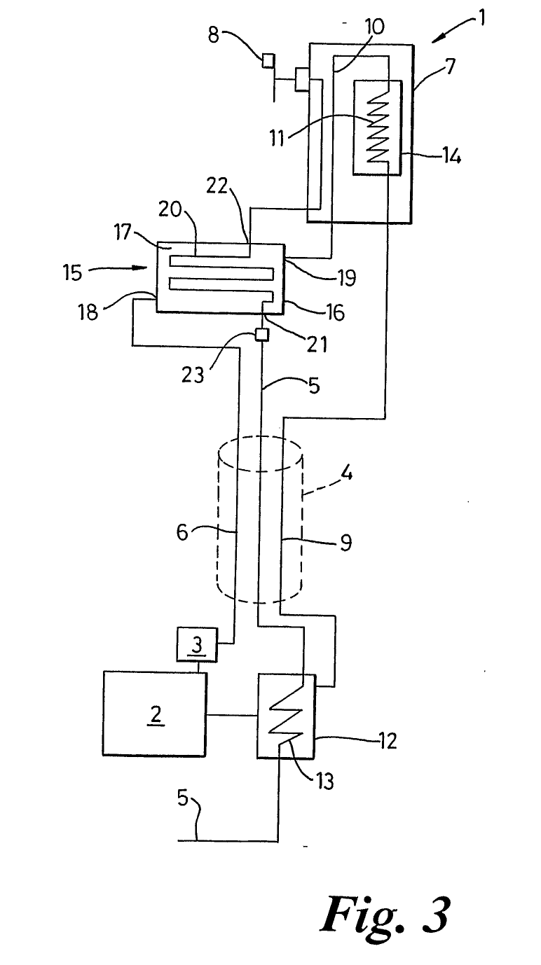

FIG. 3 shows a second embodiment of the present invention; and

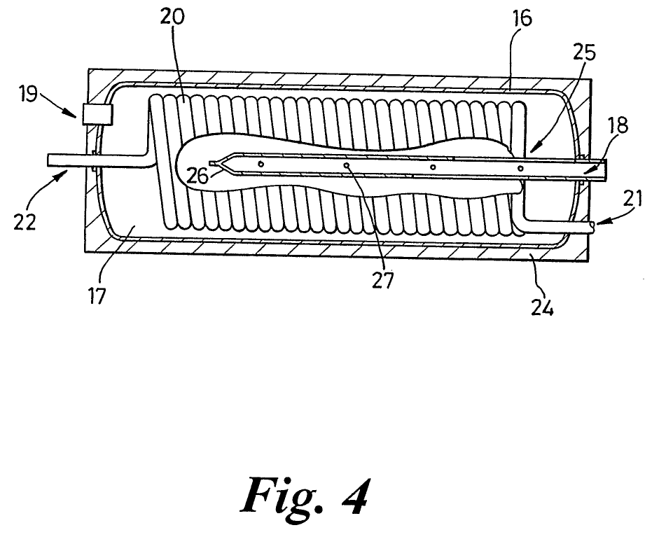

FIG. 4 shows the secondary cooler of the second preferred embodiment

FIG. 1 shows a system comprising a dispense font 1, a cooling medium generator 2, a pump 3, an insulated carrier 4, a beverage line 5, and a cooling line 6.

The dispense font 1 is located at a dispensation site, such as a bar area of a public house.

The cooling medium generator 2 comprises an ice slush generator which is a scraped wall slush ice generator such as a Taylor 438 generator. Such a generator includes a refrigeration unit which cools a wetted surface (wetted with a 10% solution of glycol) which is continuously scraped to form a two phase mixture of about 40% small ice crystals suspended in a liquid phase (predominantly water).

The system further comprises a cooling medium reservoir 12, in which slush ice from the generator 2 is stored. The reservoir 12 is insulated and contains an agitator to ensure that the slush ice remains homogenous.

The generator 2 and reservoir 12 are located at a remote site separated from the bar area; typically they are provided in a back room or cellar. The reservoir 12 may be remote from the generator 2.

The pump is a centrifugal pump such as a GP20/18 manufactured by Totton. The pump is for pumping the cooling medium through the cooling line 6. The cooling line 6 is part of a cooling circuit comprising the cooling line 6 and a return line 9. The cooling line and the return line have a diameter of 15 mm. Both the cooling line 6 and the return line 9 extend through the insulated carrier to the dispense font 1.

The insulated carrier 4 is of the type commonly known as a “python”. The python comprises a conduit in which runs the beverage line 5, the cooling line 6 and the return line 9. An insulated sheath provides the python with structural integrity and also helps to minimise heat transfer with the surroundings. The python is around 30 metres in length.

The python extends from the remote location to the dispensation site. For the sake of clarity, in FIG. 1, the python is not shown as extending the entire way between the generator 2 and the dispense font 1. In practice, the python would extend for the whole distance.

A beverage line 5 having a diameter of 9.5 mm (⅜″) passes from a beverage supply (e.g. a storage vessel such as a keg or barrel) and through the reservoir 12. The beverage line 5 includes a beverage line portion 13 which is coiled and immersed in the ice slush in the reservoir 12 to improve heat transfer between the ice slush in the reservoir 12 and the beverage. The coiled beverage line portion 13 has a diameter of 7.9 mm ( 5/16″) and an immersed length of 8.5 metres.

The number of beverage lines in the system can be varied depending on the number of dispense fonts that require connection. In the embodiment shown in FIG. 1, only a single beverage line 5 is shown for the sake of clarity.

After passing through the reservoir 12, the beverage line continues through the python to the dispense font 1.

The dispense font 1 comprises a housing 7 which is mountable on a bar or similar surface visible to the customer and on which a dispense tap 8 is mounted. The dispense tap 8 is connected to the beverage line 5. The dispense font 1 is further provided with a cooling loop 10 which is formed from the cooling line and which runs within the font housing 7 in close proximity to the beverage line 5 thus allowing heat transfer between the slush ice in the cooling loop 10 and the beverage in the beverage line 5.

There is also a condensation mechanism comprising a coiled condensation line 11 formed from the cooling line and a metal condensation plate 14, the condensation line 11 being in thermal contact with the condensation plate 14. The metal condensation plate 14 is formed on a surface of the font housing 7 which, in use, faces the customer so that a frosted/iced surface is visible to the customer.

In use, the beverage is dispensed from dispense tap 8. The beverage is dispensed by means of a gas-pressurised system (not shown) or alternatively by a pumping mechanism. Beverage is passed from a storage keg (or similar container) along the beverage line 5. The beverage passes through the coiled beverage line portion 13 immersed in the slush ice in the reservoir 12 where it is cooled to a temperature of 0° C. by heat exchange with the ice slush.

The beverage flows through the python 4 to the dispense font 1 at the dispensation site. The beverage flows through the beverage line 5 in the dispense font 1 and the low temperature of the beverage in the beverage line 5 is maintained by thermal contact with the cooling loop 10.

The pump 3 operates to pump ice slush from the ice slush generator 2 through the cooling line 6 to the cooling loop 10 and coiled condensation line 11 in the dispense font 1 and then back to the reservoir 12 through the return line 9. The flow rate is between 4 and 8 L/min with a head of no more than 18 metres (although this can be increased if the length of the python is increased).

The ice slush pumped through the cooling line 6 including through the cooling loop cools/maintains the low temperature of the beverage as it flows to the dispensation site. The ice slush pumped through the condensation line causes condensation to form and freeze on the condensation plate.

An example of the results obtained using the system and method described above is shown in FIG. 2. FIG. 2 shows a graph of beverage temperature in degrees Celsius at various stages during the dispensing process using a system corresponding to the first embodiment of the present invention (‘x’) and a conventional system (‘Δ’). The data was gathered using a single beverage line at a constant flow rate of 4 pints per minute through a system including 30 metres of python. The temperature of the ice slush was −3.3° C. (‘o’).

In the system according to the first embodiment of the present invention, the beverage leaves the cellar/storage room at a temperature of around 12° C. (the ambient temperature in the cellar). As it passes through the immersed coiled portion of the beverage line in the reservoir 12, the temperature drops to below 0° C. i.e. to −0.5° C. This temperature is maintained as the beverage flows through the python 4 to the dispensation site 1 by the slush ice (at a temperature of −3.3° C.) in the cooling line. Accordingly, the beverage exits the dispense tap at around −0.5° C. This results in an “in-glass” beverage temperature of around 1° C. as there is a 1.5° C. rise in temperature during pouring as a result of heat exchange between the beverage and the glass. This temperature rise will depend on several factors including the temperature of the beverage, the dispense tap and the glass.

In the conventional system comprising a water bath cooled by an ice bank ice and a glycol system in series with a passive under bar heat exchanger, the temperature of the beverage is reduced in the water bath from around 12° C. (the cellar temperature) to around 6° C. A glycol cooling medium is circulated through the python in cooling lines in thermal contact with the beverage line thus reducing the temperature of the beverage to around 5.5° C. A further decrease in temperature to 3.5° C. is then obtained as the beverage passes through the passive heat exchanger. This results in an “in-glass” temperature of around 5° C.

Thus it can be seen that the system of the present invention is capable of cooling a beverage to below zero degrees and maintaining this low temperature up to the dispense font without any risk of freezing or spoiling of the beverage. A conventional system is unable to achieve and maintain such a low temperature of beverage.

FIG. 3 shows an alternative embodiment of the present invention which is the same as the embodiment shown in FIG. 1 except that a secondary cooler 15 is provided. The secondary cooler 15 comprises a cooling pod (such as that described in published application GB2417064) which is shown in more detail in FIG. 4.

The cooling pod includes a housing 16 defining a cooling chamber 17. The housing 16 is surrounded by insulation 24 (for example expanded foam insulation) to minimise heat transfer between the cooling pod and the surroundings.

The cooling chamber is provided with a slush ice inlet 18 into which slush ice is pumped to flood the cooling chamber 17 and a slush ice outlet 19 from which the slush ice exits the cooling chamber to continue to the dispense font 1. An elongated pipe 25 is connected to the slush ice inlet 18. The pipe 25 has a closed end 26 distal to the slush ice inlet and a number of holes 27 spaced along the length and around the circumference of the pipe 60.

A cooling coil 20 is provided within the cooling chamber between a beverage inlet 21 and a beverage outlet 22. The beverage line 5 which has a diameter of 9.5 mm (⅜″) connects to the beverage inlet 21 and thus the cooling coil (which has a diameter of 7.9 mm ( 5/16″)) through a coupling 23 and then continues from the beverage outlet 22 to the dispense font 1.

The pipe 60 is located within the cooling coil 20 such that the slush ice exiting the holes 27 impacts as a spray on the inside surface of the coil 20.

The cooling pod is located at the dispensation site. It may be located above or below bar level and may optionally be incorporated into the housing 7 of the dispense font 1.

The python 4 preferably extends either side of the cooling pod i.e. the python may be formed of two separate pieces, one piece running from the generator 2 to the cooling pod 15 and another piece extending from the cooling pod 15 to the dispense font 1 at the dispensation site.

The provision of the cooling pod allows the temperature of the beverage to be reduced even further, to around −1.5° C. as it exits the cooling pod. This results in an “in-glass” temperature of around 0° C.

1. A system for cooling a beverage comprising:
a beverage line connectable to a beverage supply for transporting beverage from the beverage supply through an insulated carrier to a dispensation site;
a cooling medium generator for generating a cooling medium;
a cooling line for transporting the cooling medium from the cooling medium generator through the insulated carrier so as to allow heat exchange between the cooling medium in the cooling line and the beverage in the beverage line; and
a pump for pumping the cooling medium through the cooling line,
wherein the cooling medium generator is an ice slush generator.

2. A system according to claim 1 wherein the cooling medium generator is a scraped wall slush generator.

3. A system according to claim 1 further comprising a cooling medium reservoir for containing cooling medium generated by the cooling medium generator.

4. A system according to claim 3 wherein the beverage line includes a beverage line portion passing through the reservoir.

5. A system according to claim 4 wherein the beverage line portion passing through the reservoir is adapted to cool the beverage to below 3° C.

6. A system according to claim 5 wherein the beverage line portion passing through the reservoir is adapted to cool the beverage to below 2° C.

7. A system according to claim 6 wherein the beverage line portion passing through the reservoir is adapted to cool the beverage to below 0° C.

8. A system according to claim 1 further comprising a secondary cooler at or near the dispensation site.

9. A system according to claim 8 wherein the secondary cooler is a passive heat exchanger including a cooling loop through which beverage can flow.

10. A system according to claim 1 further comprising a dispense font at the dispensation site, the dispense font including a cooling loop for cooling/maintaining the temperature of the beverage.

11. A system according to claim 10, wherein the dispense font further comprises a condensation mechanism for forming condensation on the dispense font.

12. A method of cooling a beverage flowing through a beverage line from a beverage supply to a dispensation site, the beverage line passing through an insulated carrier, the method comprising:
pumping a cooling medium through a cooling line inside the insulated carrier thereby allowing heat exchange between the cooling medium in the cooling line and the beverage in the beverage line,
wherein the cooling medium is an ice slush.

13. A method according to claim 12 further comprising generating the ice slush cooling medium.

14. A method according to claim 13 comprising generating the ice slush cooling medium from water which may contain up to 10%, of a freezing point suppressant.

15. A method according to claim 13 comprising generating the slush ice cooling medium using a scraped wall slush ice generator.

16. A method according to claim 12 further comprising storing ice slush in a cooling medium reservoir.

17. A method according to claim 16 comprising flowing the beverage through a beverage line portion passing through the cooling medium reservoir prior to flowing the beverage through the beverage line in the insulated carrier.

18. A method according to claim 17 comprising cooling the beverage to below 3° C. as it passes through the beverage line portion.

19. (canceled)

19. A method according to claim 18 comprising cooling the beverage to below 0° C. as it passes through the beverage line portion.

20. A method according to claim 12 further comprising cooling the beverage using a secondary cooler at or near the dispensation site.

21. A method according to claim 20 wherein the secondary cooler is a passive heat exchanger, the method comprising passing the beverage through a cooling loop in the passive heat exchanger.

22. A method according to claim 12 further comprising pumping the cooling medium through a cooling loop in a dispense font at the dispensation site.

23. A method according to claim 12 further comprising pumping the cooling medium through a condensation line in a dispense font at the dispensation site.

24. A system for cooling a beverage comprising:
a beverage line connectable to a beverage supply for transporting beverage from the beverage supply through an insulated carrier to a dispensation site;
a cooling line containing a cooling medium, the cooling line being in thermal contact with the beverage line so as to allow heat exchange between the cooling medium in the cooling line and the beverage in the beverage line; and
a pump for pumping the cooling medium through the cooling line,
wherein the cooling medium is ice slush.

25. A system according to claim 24 wherein the ice slush is a mixture of up to 40% ice particles in (predominantly) water.

26. A system according to claim 24 wherein the temperature of the ice slush is around −3° C.

27. A system according to claim 24 wherein the ice slush contains up to 10% of a freezing suppressant.

28. A system according to claim 27 wherein the freezing point suppressant is glycol.

29. (canceled)

30. (canceled)
